(19) United States
(12) Patent Application Publication
(10) Pub. No.: US 2005/0238419 A1
(43) Pub. Date: Oct. 27, 2005

(54) Shaft for a manually operated tool and a tool

(75) Inventor: Erik Thoro Lauridsen, Vejle (DK)

Correspondence Address: FOLEY & LARDNER, 777 EAST WISCONSIN AVENUE, SUITE 3800, MILWAUKEE, WI, 53202-5308, US

(73) Assignee: Fiskars Danmark A/S

(21) Appl. No.: 10/501,484

(22) PCT Filed: Jan. 17, 2003
(86) PCT No.: PCT/DK03/00032

§ 371 Date: Apr. 11, 2005

(30) Foreign Application Priority Data
Jan. 18, 2002 (DK) PA 2002 00091

(51) Int. Cl. F16D 1/12

(52) U.S. Cl. 403/92

(57) ABSTRACT

The handle comprises an elongate shaft portion (3) with a handle end (3a), a tool end (3b), a longitudinal axis (5) and a pivot joint (4) comprising two joint members having a pivot axis (6) for rotating relative to each other and extending under an angle (α) relative to the longitudinal axis (5) and having swivel surfaces (10) which are in mutual engagement and slide against one another during rotation, in which the pivot joint (4) comprises a indentation mechanism comprising engagement means on one of the joint members, said engagement means being adapted to engage corresponding engagement means on the second joint member to determined a plurality of discrete mutual angle positions in respect of the two joint members. The engagement means comprises engagement faces, which are oblique, whereby the engagement may be released by subjecting the two joint members to oppositely directed torques exceeding a definite size and least one spring means is present for actuating the engagement means of the two joint members towards mutual engagement. The angle (α) between the longitudinal axis (5) and the pivot axis (6) is 20-70°.

### BACKGROUND

The present invention relates to a handle for a hand tool according to the preamble of claim 1.

A handle of this art is known from U.S. Pat. No. 4,673,307 which relates to washing brush with adjustable head, said head being rotatable in plane parallel to the free ends of the bristles of the brush.

Especially the present invention relates to a handle for a manually operated tool, comprising an elongate shaft portion with a handle end and a tool end, in which a straight line passing through the handle end and the tool end defines a longitudinal axis of the handle, a connection portion for connection with a tool head and a pivot joint between the tool end of the shaft portion and the connection portion, said pivot joint comprising two joint members having a pivot axis for rotating relative to each other and extending under an angle relative to the longitudinal axis and having swivel surfaces which are in mutual engagement and slide against one another during rotation.

U.S. Pat. No. 6,128,800 discloses a brush, in which the handle is connected with the brush head in such a manner that the handle may swing from one side to the other relative to the head, the angle between the longitudinal axis of the handle and the axis of rotation being 90°. One of the joint members has engagement members in the form of a number of radial indentations and the second joint member has engagement means in the form of a radial rib respectively extending over an entire diameter. A screw is used for clamping the two joint members in a chosen mutual angle position. For changing of the angle positioning, the screw is loosened; the handle and the brush head are taken hold of by the hands and turned relative to each other, following which the screw is tightened again.

U.S. Pat. No. 4,902,392 discloses a brush, the handle of which is pivotally mounted at the side of the brush head by means of a screw extending transversely through the brush head and determining a pivot axis, whereby the angle between the longitudinal axis of the handle and the pivot axis is approximately 50°. Apart from a friction, if any, between the movable members, no locking device for retaining the mutual position of the head and the handle is mentioned. A gear mechanism at the brush head is used in some embodiments for adjusting the angle between the handle and the head. Movement of these two members are not impeded, and it is an object aimed at that the brush is to turn, if it hits a solid article during use. On one side it does not seem particularly practical that for changing the angle between handle and head the brush has to be lifted and the angle adjusted by turning of a gear wheel, it is, on the other hand, not particularly practical that it is not sometimes possible to transfer a forceful twist from the brush handle to the head or the other way round.

U.S. Pat. No. 3,273,192 discloses a paint roller with a shaft with a pivot joint having a pivot axis angled 90° relative to the longitudinal axis of the shaft. The pivot joint comprises two disc shaped serrated swivel surfaces and a nut-and-bolt mechanism for locking the joint in a desired position or releasing the joint for adjustment.

U.S. Pat. No. 5,860,902 discloses a paint roller with a shaft with one or more pivot joints having pivot axes that are oblique relative to the longitudinal axis of the shaft. The joints comprise disc shaped, possibly serrated swivel surfaces and nut-and-bolt mechanisms for either releasing the joints for adjustment or locking the joints to keep the positions obtained by the adjustment.

### SUMMARY

The object of the invention is to provide a handle, which makes a tool like for instance a sweeping brush; a rake, a leaves rake, a push hoe, a weed hoe or some other tool, in particular a household or gardening tool having a preferably long handle, more flexible and easy to handle.

It will be appreciated edit a tool with a long handle, i.e. a long-handled tool, in general is a tool with a long handle allowing a user holding the handle to keep his hands in a substantial distance from the tool head.

The object is attained by means of a handle of the type mentioned by way of introduction, which is characterized by the features of the characterizing part of claim 1. Preferred embodiments are defined in the dependent claims 2-11.

In one embodiment the pivot joint comprises a indentation mechanism comprising engagement means on one of the joint members, said engagement means being adapted to engage corresponding engagement means on the second joint member to determine a plurality of discrete mutual angle positions in respect of the two joint members, the engagement means comprising engagement faces which are oblique in such a manner that the engagement may be released by subjecting the two joint members to oppositely directed torque forces exceeding a definite size, at least one spring means being present for actuating the engagement means of the two joint members towards mutual engagement.

By combining the oblique angle and the indentation mechanism in the pivot joint is obtained that a tool by an active twist of the handle may be adjusted to a definite angle between the head and the handle and that the angle chosen is then maintained as long as the forces acting on the tool do not exceed a certain size.

The engagement means are preferably closely spaced and equidistant. In this manner a bigger number of adjustment possibilities is attained.

In a preferred embodiment the engagement means of one of the pivot of one of the swivel surfaces are constituted of indentations or elevations with face areas extending substantially radial and obliquely converging towards the bottom of the individual indentation or to the summit of the individual elevation relative to a direction in parallel with the pivot axis, and that said spring means is a spring for biasing the two joint members against each other The oblique surfaces of the engagement means ensure that an applied torque on the two joint members relative to one another will make them slide away from each other against the force of the spring to release the engagement. When the torque is released after a desired turning, the spring will again bring the two joint members towards each other in a new engagement between the engagement means.

The engagement means are preferably closely spaced and equidistant. Hereby, an increased number of adjustment possibilities are attained, and it is ensured that a new engagement between the engagement means will always be established, when an engagement breaking torque is released.

The engagement means may then adequately be teeth and intermediate indentations. Each tooth has preferably a triangular cross section in a plane in parallel with the pivot axis and perpendicular to the radius from the pivot axis to the tooth. Moreover, the teeth have preferably a vertex angle of 80-120°, preferably 90-110. This provides a good engagement between the joint members for retention of a definite adjustment, while an adequate torque on the handle about its longitudinal axis will change the adjustment.

In a preferred embodiment the pivot joint comprises a pin, which is retained in one of the joint members and extends through the other joint member coaxially with the axis of rotation, said pin being connected with a clamping member, whereby mutual rotation of the latter and the pin brings them into a mutual position, in which they allow the two joint members to move away from each other along the axis of rotation against the influence of the spring to allow mutual turning of the two joint members, while by turning to a second mutual position they impede such a movement. In this manner it becomes possible to lock the handle and the head in a chosen mutual position. The pin and the member rotatable relative thereto may be a screw or a nut like in U.S. Pat. No. 6,128,800.

However, the clamping member preferably comprises an eccentric portion, which is pivotal about an axis perpendicular to the pivot axis. In this manner, a particularly easy and quickly operable locking possibility is provided.

In a further preferred embodiment the spring is a coil spring positioned coaxially about the pin between the second joint member and the clamping member, an annular member being positioned coaxially about the pin between the spring and the clamping member and having a U-shaped cross section along the axis of rotation, the spring abutting the bottom of the L and the legs of the U abutting the second joint member, when the clamping member is in the second position.

The elongate shaft portion may be rectilinear, in which case the longitudinal axis will be coinciding with the centre axis of the shaft portion. Alternatively the shaft portion may be curved or S-shaped, as it is known per se.

### BRIEF DESCRIPTION OF THE DRAWINGS

The invention will be described in detail in the following by means of an example of an embodiment with reference to the schematic drawing, in which

FIG. 1 is a lateral view of a brush with a handle according to the invention,

FIG. 2 is an exploded view of the pivot joint in FIG. 1.

### DETAILED DESCRIPTION OF THE PREFERRED AND OTHER EXEMPLARY EMBODIMENTS

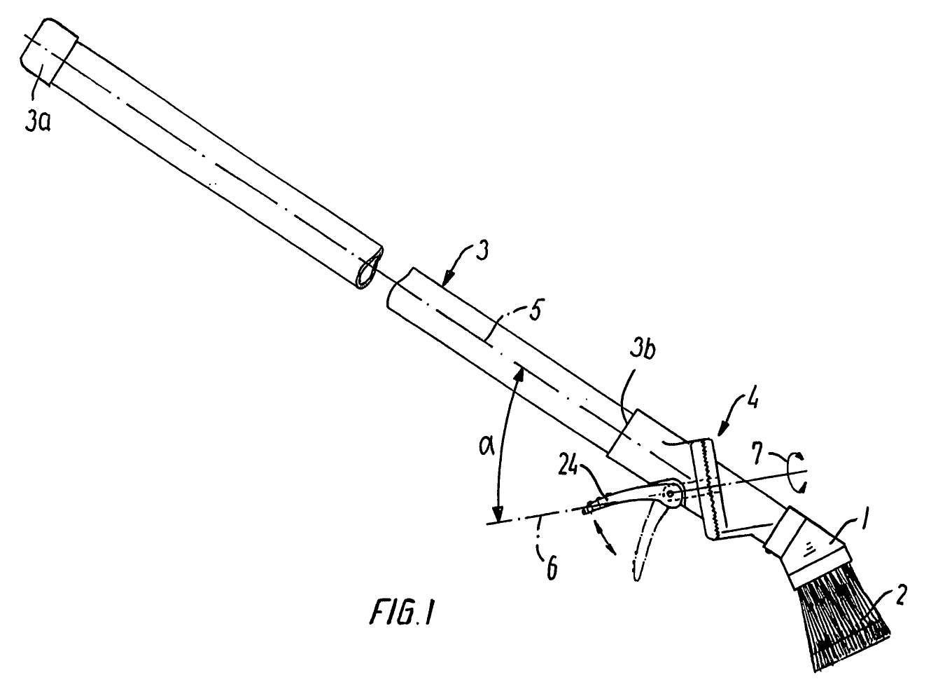

FIG. 1 shows a brush with a brush head 1 with bristles and a rectilinear shaft portion 3 with a handle end 3a and a tool end 3b. The brush head 1 is connected with the tool end 3b of the shaft portion by means of a pivot joint 4, whereby the brush head 1 is pivotal relative to the shaft portion 3 and its longitudinal axis 5 about a pivot axis 6 extending under an angle a of approximately 45° as indicated by the arrow 7.

The mutual position of the brush head 1 and the shaft portion 3 can be locked by means of a pivotal handle 24. A detailed explanation will be given below.

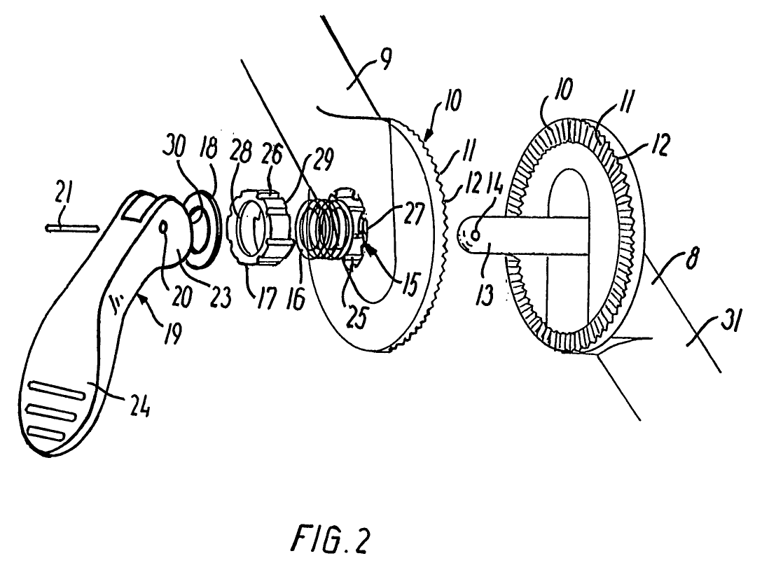

FIG. 2 shows the pivot joint 4 in an exploded view with a first joint member 8 for connection with the brush head 1 and a second joint member 9 for connection with the tool end 3b of the shaft portion 3. The two joint members a, 9 each have a swivel surface 10 with engagement means in the form of teeth 11 and intermediate indentations 12. The teeth have a triangular cross section with a vertex angle of approximately 100°. The indentations have a corresponding cross section. The level difference between the points of the teeth and the bottoms of the indentations is approximately 2 mm.

Centrally, relative to the swivel surface 10 and extending perpendicularly thereto the first joint member is provided with a circular-cylindrical pin 13 with a through hole 14 at its free end.

By assembly of the pivot joint 4, the two joint members 8 and 9 are brought together, the pin 13 penetrating through a through hole 15 in the second joint member 9, whereby the two swivel surfaces 10 are brought into abutment against one another, their respective teeth 11 and indentations 12 being in mutual engagement. The pin is passed further on through a coil spring 16, a ring member 17 with U-shaped cross section, a washer 18 and into a clamping member 19 with a through hole 20 in such a manner that the hole 14 of the pin 13 is in alignment with the hole 20. A locking pin 21 is pressed into the two holes 14 and 20 to keep the pivot joint assembled.

The clamping member 19 consists of an eccentric portion 23 and the handle 24, and it may by means of the handle 24 be turned around the locking pin 21 between the release position shown in FIG. 1 by a fully drawn line and the locking position shown by a dot-and-dash line.

The hole 15 in the second joint member 9 has at its end closest to the first joint member 8 a diameter corresponding to the diameter of the pin 13 with a suitable clear to avoid friction. In the opposite end the hole has a bigger diameter and the sidewalls of the hole are there provided with axial ribs 25 cooperating with indentations 26 in the surface of the ring member 17 in such a manner that the latter cannot pivot about the pivot axis when it has been accommodated in the hole 15.

A radial extending shoulder 27 forms a transition between the two ends of differing diameter in the hole 15. This shoulder 27 constitutes an abutment face for the ring member 17 and the coil spring 16.

The ring member 17 has an internal diameter enabling it to receive the coil spring 16. The ring member has due to its U-shaped cross section an annular flange 28 extending around the pin 13, when the pivot joint 4 is assembled, a suitable clear being provided between the pin 13 and the annular flange 28 for prevention of friction. The annular flange 28 forms the bottom of the U and constitutes an abutment for the coil spring 16.

The ring member 17 is at its end surface 29 corresponding to the free ends of the legs of the U provided with a two-parted helicoid surface, as will be seen from FIG. 2, and the shoulder 27 is correspondingly designed. Thereby, the mutual turning of the joint member 9 and the ring member 17 will bring about an adjustment of the distance between the shoulder 27 and the annular flange 28, when the ring member 17 is in abutment against the shoulder 27. This may be used for compensation of production tolerances and adjustment of an abutment pressure in a locked position, which will be described in detail in the following. The division in two of the helicoid surfaces ensures that there is always a mutual symmetrical abutment between the helicoid surfaces around the pivot axis 6.

The eccentric portion 23 of the clamping member 19 is provided with an abutment surface 30 extending eccentrically relative to the hole 20. Thus, the distance from the hole 20 and consequently the locking pin 21 to the abutment point against the washer 18 and consequently the ring member 17 is smaller, when the clamping member 19 is in its release position than when the clamping member 19 is in the locking position.

When the clamping member 19 is in the locking position, all members of the pivot joint 4 are tightly clamped, i.e. the engagement means of the swivel surfaces 10 are fully engaged, the ring member 17 is in abutment against the shoulder 27, the washer 18 is in abutment against the ring member 17 and the abutment surface 30 of the clamping member 19 is in abutment against the washer 18. It is therefore not possible for the engagement means 11, 12 on the two swivel surfaces 10 to become disengaged, for which reason the pivot joint 4 is locked in its position.

When the clamping member 19 is moved to the release position, the distance from the shoulder 27 to the abutment surface 30 is increased, and therefore the coil spring 16 will push the ring member 17 slightly in a direction out of the hole 15, whereby a clear between the ring member 17 and the shoulder 27 is provided. The coil spring takes care of maintaining a certain tension in the remaining of the abovementioned abutments.

In the latter position, it is possible for the two joint members 8 and 9 to recede from each other, if for instance a person using the brush with a firm grip around the shaft portion 3 twists it about the longitudinal axis 5 and thus subjects the pivot joint 4 to a torque. If the brush is kept in a normal position of use with the handle oblique relative to the surface to be worked, said surface will through the brush head yield resistance against the twisting movement. Then, the oblique surfaces of the teeth 11 on the two swivel surfaces 10 slide against one another and push the pivot members 8 and 9 from each other, until the mutual engagement of the joint members 8 and 9 is released, and the two pivot members 8 and 9 are turned relative to each other until the teeth 11 fall into place in the next indentation 10. Thus, the two pivot members 8 and 9 will be turned stepwise relative to each other, until the user stops twisting the shaft portion 3. The brush may be used in the new position until a certain torque-providing load is applied. If this load is exceeded and if it is desired to maintain the position, the pivot joint 4 may be locked by means of the handle 24.

The user may control the handle 24 by his foot. The brush and its adjustment may thus take place without the need for the user to leave his upright working position and without the brush having to be lifted.

The first pivot member 8 intended for connection with the brush head has preferably a pin 31, not shown in detail, for connection with the brush head. This pin 31 may be designed in the same manner as a common handle end whereby the handle described may replace a common handle not only of a brush, but alternatively of a rake, a leaves rake, a floor scrubber, a weed hoe and in all other places, where a handle with the described turning function is desired. It is also possible to construct the pin 31 and thus the first pivot joint 8 integral with the tool head in question.

1. A handle for a hand tool, comprising a shaft member having a longitudinal axis and a first end adapted for handling by a user and a second end adapted for coupling to a tool head and a pivot joint coupled to the shaft member and configured to reposition the tool head, the pivot joint including a first swivel surface and a second swivel surface that are substantially parallel and oriented in planes oblique to the longitudinal axis, the oblique planes having a normal axis forming an angle substantially within the range of 20 degrees to 70 degrees with the longitudinal axis, and a clamping member configured to position the swivel surfaces in a first position and a second position, so that the swivel surfaces are substantially restricted from relative movement in the first position and the swivel surface are capable of relative movement in the second position against the influence of a spring member.

2. The handle for a hand tool of claim 1 wherein the tool head is movable about the normal axis.

3. The handle for a hand tool of claim 1 wherein the tool head is positionable in a plurality of positions defined by the relative movement of the swivel surfaces.

4. The handle for a hand tool of claim 1 wherein the swivel surfaces are substantially circular.

5. The handle for a hand tool of claim 1 wherein the swivel surfaces comprise a series of coacting ridges and valleys.

6. The handle for a hand tool of claim 5 wherein the ridges and the valleys are a series of teeth having a substantially triangular cross-section.

7. The handle for a hand tool of claim 1 wherein the spring member is configured to bias the swivel surfaces into an abutting relationship.

8. The handle for a hand tool of claim 1 wherein the clamping member comprises a lever member having an eccentric portion.

9. The handle for a hand tool of claim 1 wherein the angle is substantially within the range of 30 degrees to 60 degrees.

10. The handle for a hand tool of claim 1 wherein the angle is substantially within the range of 40 degrees to 50 degrees.

11. The handle for a hand tool of claim 1 wherein the angle is substantially 45 degrees.

12. A tool having a shaft and a tool head, comprising a pivot mechanism operably coupled between at least a portion of the shaft and the tool head, the pivot mechanism including a first surface and a second surface configured in a substantially parallel relationship defining an oblique plane relative to the shaft, the surfaces having coacting engagement structure, and a clamping device having a handle movable between a first position where the coacting engagement structure is configured to substantially restrict relative movement between the first surface and the second surface and a second position where the coacting engagement structure is configured to permit relative movement between the first surface and the second surface, so that the tool head may be repositioned relative to at least a portion of the shaft.

13. The tool of claim 12 wherein the coacting engagement structure comprise teeth.

14. The tool of claim 12 further comprising a spring configured to bias one of the surfaces away from the other of the surfaces.

15. The tool of claim 14 wherein the handle includes a cam portion configured to prevent separation of the surfaces when the handle is in the first position and configured to permit separation of the surfaces by the spring when the handle is in the second position.

16. The tool of claim 12 wherein the surfaces have a substantially common normal axis and at least one of the surfaces is configured to rotate relative to the other of the surfaces when the handle is in the second position.

17. The tool of claim 16 wherein the pivot mechanism further comprises a pin member extending at least partially along the normal axis.

18. The tool of claim 17 wherein the handle is pivotally coupled to the pin member.

19. A tool having a shaft including a first end coupled to a tool head and a second end having a grip portion, the tool comprising a pivot mechanism operably coupled between at least a portion of the tool head and the grip portion, the pivot mechanism including a first surface and a second surface configured in a substantially parallel relationship defining an oblique plane relative to the shaft, the surfaces having mutually engagable structure, and a clamping device having a handle movable between a first position where the structure are engaged to restrict movement between the surfaces and a second position where the structure are disengaged to permit movement between the surfaces, so that the tool head may be angularly repositioned relative to the shaft.

20. The tool of claim 19 wherein the clamping member further comprises a spring configured to bias one of the surfaces away from the other of the surfaces and permit relative rotation of the surfaces about an a common normal axis of the surfaces.
